(19) United States
(12) Patent Application Publication
(10) Pub. No.: US 2013/0061762 A1
(43) Pub. Date: Mar. 14, 2013

(54) Beverage Preparation Machines

(71) Applicant: Simon Carr, Bloxham (GB)

(72) Inventors: Simon Carr, Bloxham (GB); Gary Burton-Wilcock, Kidlington (GB)

(21) Appl. No.: 13/508,320

(22) PCT Filed: Nov. 12, 2010
(86) PCT No.: PCT/GB2010/002094

§ 371 Date: Sep. 24, 2012

(30) Foreign Application Priority Data
Nov. 12, 2009 (GB) 0919852.4

(51) Int. Cl. A47J 31/06

(52) U.S. Cl. 99/295

(57) ABSTRACT

A beverage preparation machine of the type which uses pre-packed cartridges of beverage ingredients. The cartridges may be designed so that air becomes entrained so as to produce a desired foam or crema. Air inlets are provided in an outlet nozzle to allow air to enter the beverage preparation machine and so be available for entrainment. Advantageously, the air inlets extend through the sides of the nozzle in an elevated position at a widened portion of the nozzle. This reduces the flow of beverage into and through the air inlets, aiding cleanliness.

The present invention relates to improvements in beverage preparation machines and in particular to a beverage preparation machine of the type which uses pre-packaged containers of beverage ingredients.

Coffee houses have been a part of the “coffee culture” since the 17^{th} century. Throughout the years methods of making coffee have been refined and skilled people trained to produce the best coffee beverages. The first coffee machines were developed in the early 1800s and an automatic espresso machine was invented in the 1930s. The automation of the coffee making process has, in turn, lead to a rapid growth, particularly in the last ten years, in the number of coffee houses/shops with more specialist drinks, such as espresso and cappuccino, being in high demand. These types of beverages have historically been regarded as luxury items because of the need for expensive, complex machines capable of producing the high pressures necessary for making them, which had to be properly operated and maintained by a trained barista to produce good quality. Coffee aficionados agree that an espresso can be spoiled by a badly trained operator despite the use of a good quality machine and good quality coffee. This trend, however, has not only lead to an increased demand from consumers for luxury top quality beverages, but also a desire for a greater variety of speciality beverages, and the ability to make such beverages in the comfort of one's own home.

Although there is no agreed technical definition, it is generally understood that, compared to drip coffee, barista quality espresso has a thicker consistency, due to a higher amount of dissolved solids and fine oil droplets suspended throughout the drink. It has a smooth, yet thick, dark reddish brown crema making up 10 to 30% of the beverage. The crema is a polyphasic emulsion of air and the oils, proteins and sugars extracted from the coffee which is produced at a high pressure, traditionally in the region of 9 to 10 bar. The higher pressures increase the rate of coffee wetting and improve extraction as well as being responsible for the development of the crema. Air is entrained into the beverage as it is being brewed to produce the desired crema.

It is acknowledged, by discerning espresso drinkers, that espresso produced using water which is cooler than the optimum temperature tastes sour and that produced with water which is hotter than this temperature tastes bitter. The optimum temperature is claimed to be between 92 and 96° C. Other factors which affect the quality of the espresso include the roasting and age of the coffee beans, the grind size, the compaction of the grinds prior to brewing, and the brew time. The “best” espresso is achieved by balancing these key elements of the brewing process.

Domestic coffee machines have also developed significantly since the first filter machines were invented in the 1960s and coffee machines are now essential pieces of kitchen equipment in many households. Some such machines dispense individual servings of a beverage directly into a drinking receptacle, and derive the beverage from a bulk supply of beverage ingredients or from individual packages of beverage ingredients such as pods, pads or cartridges. In the following specification such packages will be referenced by the general term cartridges. Machines that use such cartridges require far less cleaning and can enable the user to make a selection of beverages. The beverages are formed from brewing, mixing, dissolving or suspending the beverage ingredients in water. For example, for coffee beverages, heated water is forced through the cartridge to form the extracted solution. The cartridge may be designed so that air becomes entrained so as to produce a desired foam or crema. Air inlets are provided to allow air to enter the beverage preparation machine and so be available for entrainment within the cartridge. For example, the outlet nozzle of the machine may include an air inlet passage to allow air to pass up into the machine and through to the cartridge where it may become entrained in the flow of beverage being dispensed to assist in forming the desired foam or crema. The use of cartridges in domestic coffee machines has become increasingly popular due to their convenience and the quality of the beverage produced. An example of a machine for preparing beverages using cartridges is described in EP-A-1440644, and examples of cartridges are described in EP-A-1440903.

With the change in consumer trends, however, there is a desire for domestic machines which are capable of producing barista quality espresso and a range of other beverages, for which no training is necessary, which are affordable and which require little or no cleaning.

Accordingly, the present invention provides a beverage preparation machine configured to dispense a beverage through an outlet nozzle. The outlet nozzle has one or more sides that define a conduit between an entrance and an exit. The conduit widens downstream of the entrance to form a wider portion. Beverage may pour down the conduit before exiting the outlet nozzle and hence the beverage preparation machine. The outlet nozzle further comprises one or more air passages that extend through the one or more sides of the nozzle to provide fluid communication between the conduit and atmosphere. This allows air to be drawn into the beverage preparation machine as a beverage is dispensed. This allows air to flow into the beverage machine to replace air exiting the beverage machine with the beverage. For example, for all beverages including those like tea that do not have a foam, air is drawn downwards with the flow of beverage through the outlet nozzle. For beverages with a foam, air is also lost from the beverage machine in the air entrained within the beverage. In both cases, the air inlets provide a path for a flow of air to enter the beverage machine and replace the air that is lost. The air may flow into the beverage machine, as required, for example to be drawn into a cartridge where it is entrained into the beverage. Where a beverage does not have a foam, the air passages do not result in an adverse effect: they merely allow air drawn out by the beverage flow to be replaced.

At least some of the air passages provided, and preferably all of the air passages provided, are located in an elevated position in the wider portion above the exit of the outlet nozzle. It should be appreciated that in the following description, reference to each of the air passages need not necessarily mean each and every air passage provided in the outlet nozzle but, in its broadest sense, may mean each of a subset of the air passages provided. Thus, the outlet nozzle may comprise one or more air passages in an elevated position and one or more air passages at the exit of the outlet nozzle.

Preferably, the one or more air passages are paired, with each pair of air passages facing each other across the conduit. Optionally, the one or more air passages are equally spaced around the outlet nozzle.

Providing one or more air passages in elevated positions is advantageous as it lessens the chance of beverage entering the one or more air passages. With no beverage entering the air passages, they will remain cleaner for longer. Thus the need to clean may be avoided or, at the very least, much reduced. As the one or more air passages are provided in the side of the outlet nozzle, and may extend directly through the side, they may be very short which further aids ease of cleaning.

This effect of inhibiting beverage flow into the air passages may be optimised in many different ways. For example, greater benefit may be achieved by raising the position of the air passages by a greater degree. For example, each of the one or more air passages may be located adjacent the entrance to the outlet nozzle. Another way of optimising the effect is to try to ensure that the beverage does not flow close to the air passages. This is achieved by widening the conduit and placing each of the one or more air passages in the wider portion of the conduit. Widening the conduit also advantageously provides a head space around the flow of beverage. Thus, the air passages allow air to be drawn into the head space around the beverage. The air passages provided in the conduit do not lead to entrainment of air into the beverage flow within the conduit. As described above, for all beverages, air will be drawn downward with the beverage flow through the conduit although this will lead to little, if any, entrainment. Rather, air flow will be down the head space around the beverage flow. Where entrainment is desired, air flowing in through the air passages may flow up into the beverage preparation machine, for example to a cartridge where the air is entrained into the beverage flow, as described above. Thus, the air inlets do not lead to air entrainment within the outlet nozzle. Instead, the outlet nozzle acts merely to preserve a foam where present, and to preserve the absence of a foam where not present.

Widening of the conduit may be achieved by providing a shoulder in the conduit to define a narrower portion and the wider portion. Each of the one of more air passages may be located in the wider portion at the shoulder to shelter them from the flow of beverage. The shoulder may be stepped or it may be curved so as to be gradual.

The outlet nozzle may or may not be formed as a single piece. For example, the outlet nozzle may be an assembly of two or more parts. Optionally, the outlet nozzle comprises first and second parts that join together to form the conduit, with the one or more air passages being formed at the joint between the first and second parts. The two parts may be joined in any common way. In a contemplated embodiment, the first part is provided with a downwardly-extending rim and the second part is provided with an upwardly-extending rim, the two rims being sized such that one is received snugly within the other and being provided with interruptions that are aligned to form air passages through the joint. The rims may be used to secure the first and second parts to each other, e.g. using co-operating screw threads.

As noted above, the present invention finds useful application in beverage preparation machines that are arranged to prepare beverages from a cartridge containing one or more beverage ingredients. Typically, such cartridges are received in a cartridge holder that may be closed to seal the cartridge within the machine such that fluid like water can be passed through the cartridge to prepare the beverage. The prepared beverage exits the cartridge and is dispensed through the outlet nozzle of the machine. The machine may further comprise a piercer positioned to pierce the underside of a cartridge when placed in the cartridge holder. Typically, the piercer will pierce a laminate such as a foil provided on the underside of the cartridge. The piercer may have a hollow centre to form an outlet for beverage to exit the cartridge. The entrance to the hollow centre of the piercer may form the entrance to the outlet nozzle, i.e. the piercer may form part of the outlet nozzle.

Furthermore, the outlet nozzle may comprise first and second parts that join together to form the conduit. The first part may comprise the piercer on its topside and a downwardly-extending rim on its underside with the hollow centre of the piercer extending from the piercer to end within the rim such that the rim encircles the hole through the first part. The second part may comprise an upwardly-extending rim. Preferably, the two rims are sized such that one is received snugly within the other and are provided with interruptions that are aligned to form air passages through the joint. The hole may extend through the first part to terminate centrally within the downwardly-extending rim. This rim may be set back from the hole to form a shoulder in the conduit through the outlet nozzle. Where the upwardly-extending rim of the second part is received within the downwardly-projecting rim, the internal diameter of the upwardly-projecting rim may be such that it is spaced back from the hole so as to form a shoulder. The hole through the first part may become wider as it passes from the topside to the underside, for example by forming its side wall to curve. The curvature may see the side wall smoothly transition into the underside of the first part. The downwardly-projecting rim may extend from or adjacent to the region where the side wall transitions into the underside.

The present invention also provides a method of preparing beverages using a beverage preparation machine according to any of the preceding paragraphs. The method may comprise causing the machine to dispense a beverage through the outlet nozzle such that substantially no beverage flows through the one or more air passages. Where the beverage preparation machine is adapted to prepare beverages from a cartridge containing one or more beverage ingredients, the method may further comprise placing such a cartridge into a cartridge holder of the beverage preparation machine, causing the machine to prepare a beverage from the cartridge and to dispense the beverage so prepared through the outlet nozzle such that substantially no beverage flows through the one or more air passages.

Preferred embodiments of the present invention will now be described, by way of example only, with reference to the accompanying drawings in which:

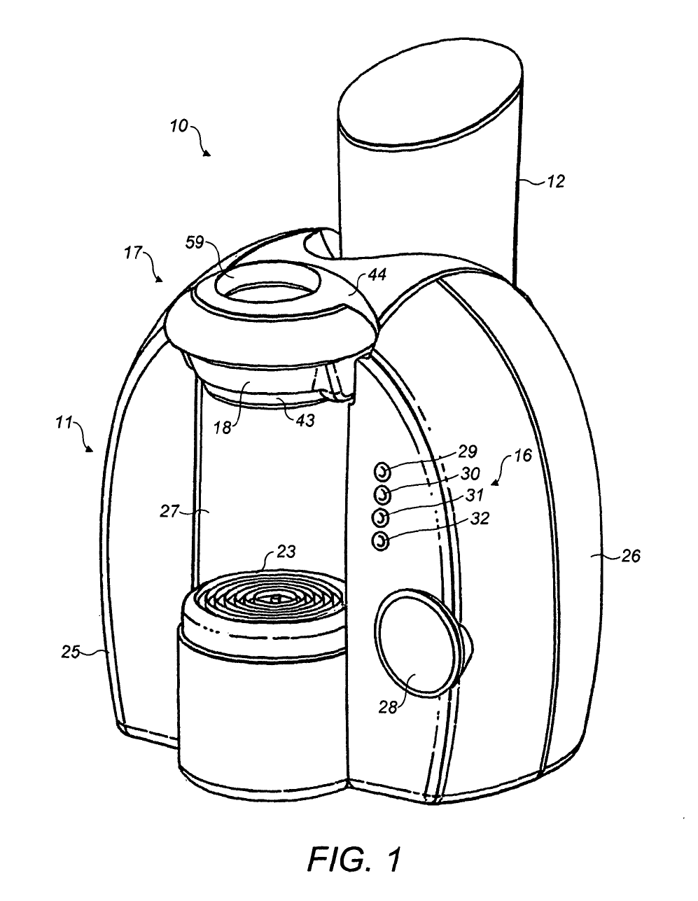

FIG. 1 is a front perspective view of a prior art beverage preparation machine with the cartridge head in a closed position;

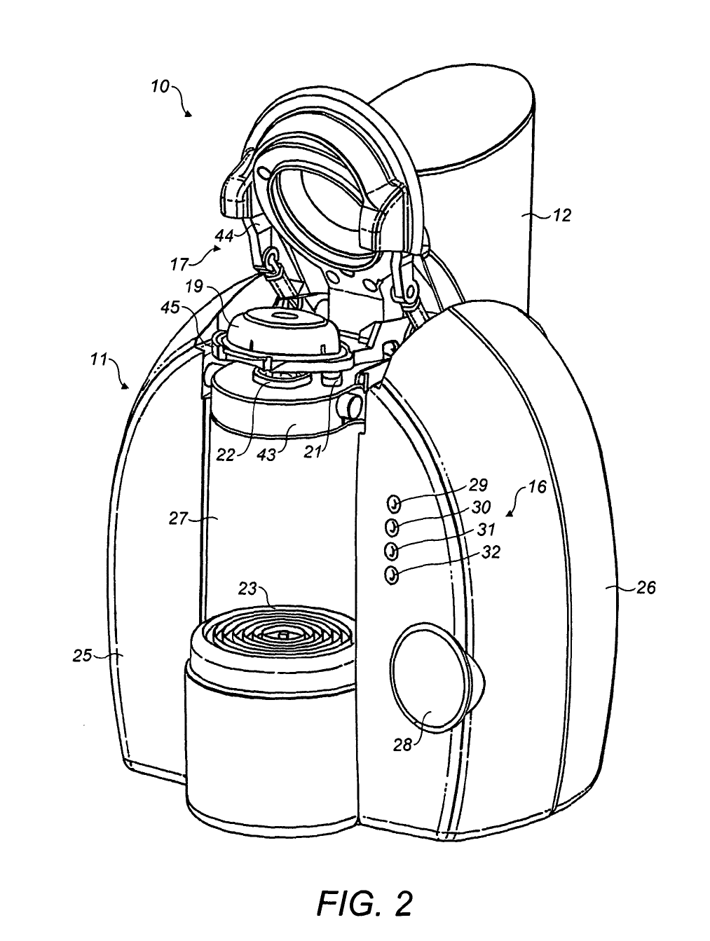

FIG. 2 is a front perspective view of the machine of FIG. 1 with the cartridge head in an open position;

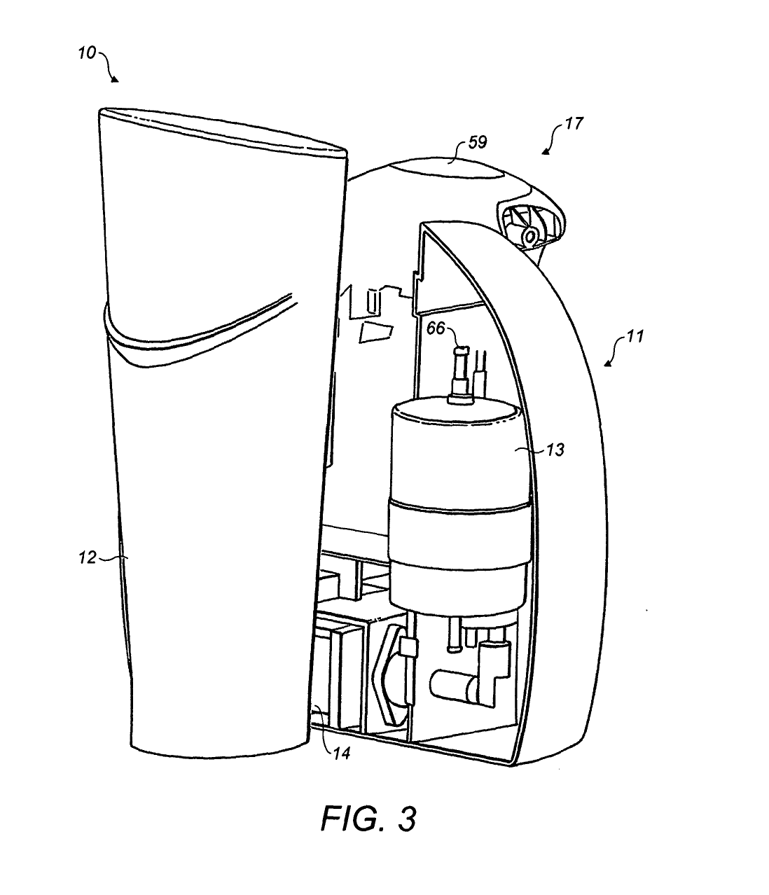

FIG. 3 is a rear elevation of the machine of FIG. 1 with some parts omitted for clarity;

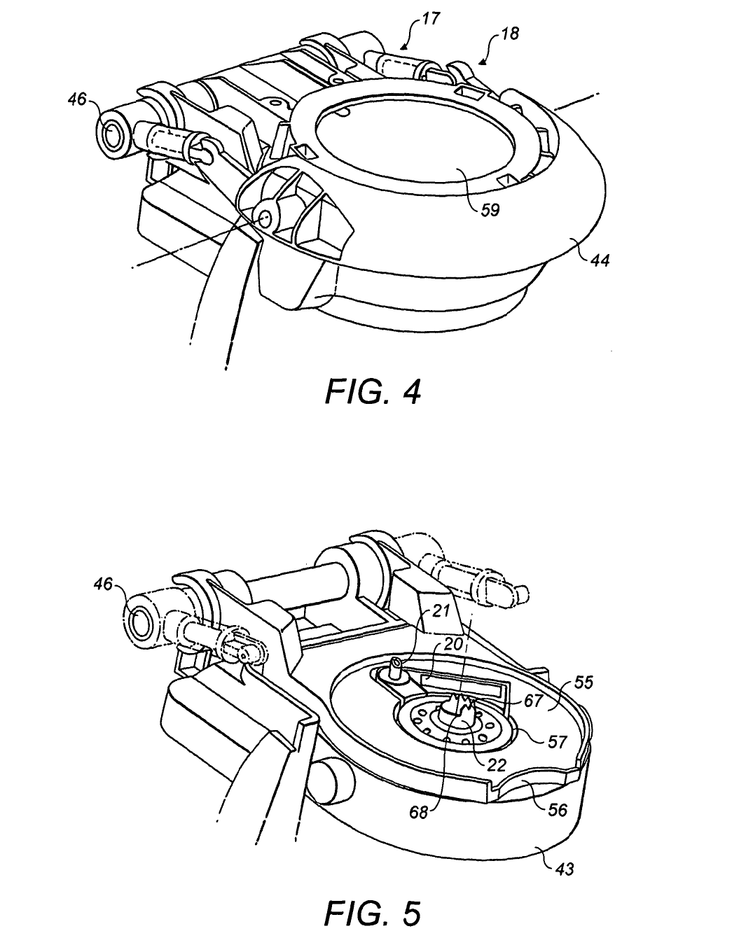

FIG. 4 is a front perspective view of a cartridge head of the machine of FIG. 1, with some parts omitted for clarity;

FIG. 5 is another front perspective view of the cartridge head of FIG. 4, with some parts omitted for clarity;

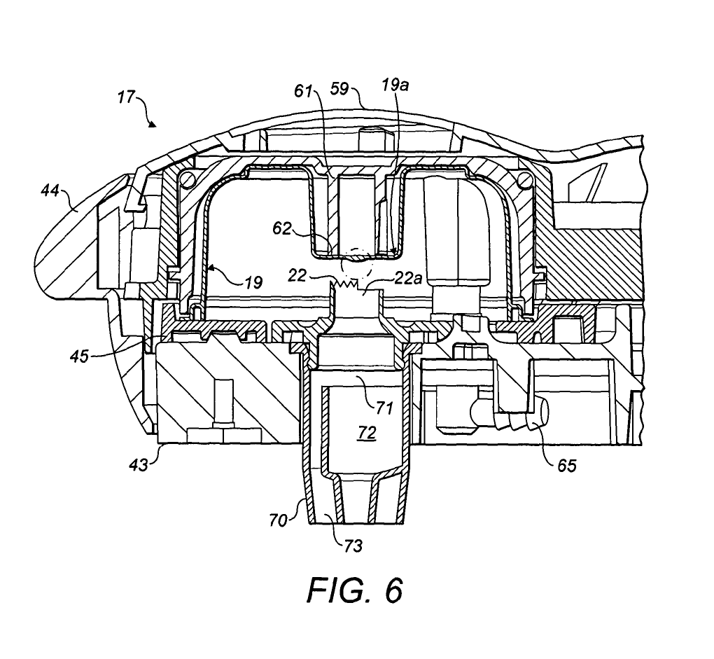

FIG. 6 is a cross-sectional view of the cartridge head of FIG. 4 in a closed position accommodating a beverage cartridge;

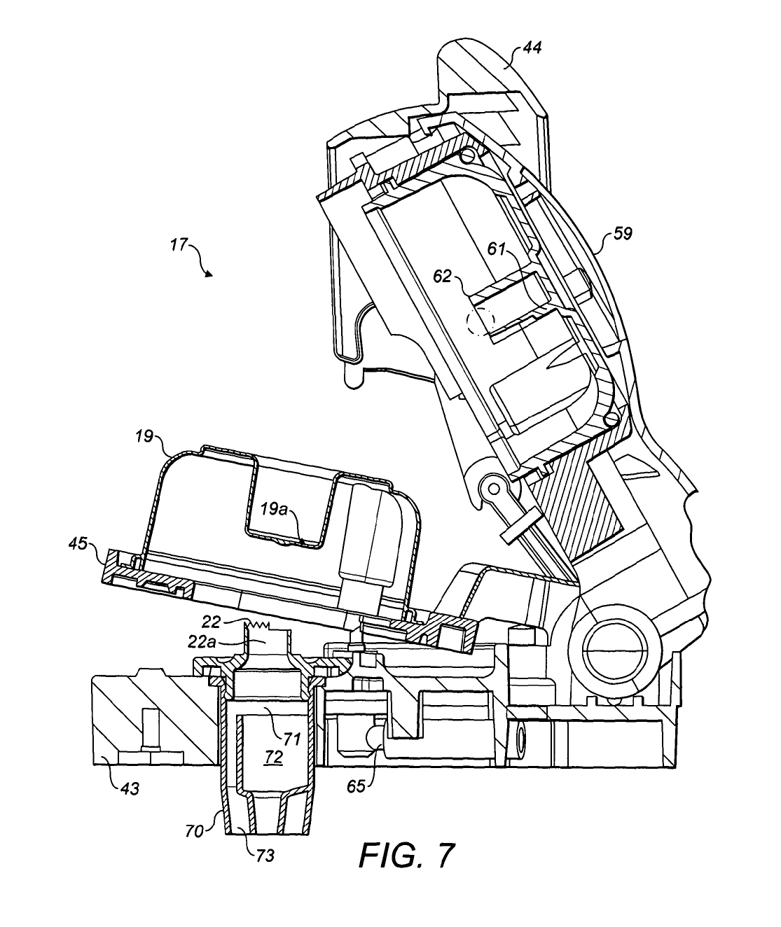

FIG. 7 is a cross-sectional side elevation of the cartridge head of FIG. 4 in an open position accommodating the beverage cartridge;

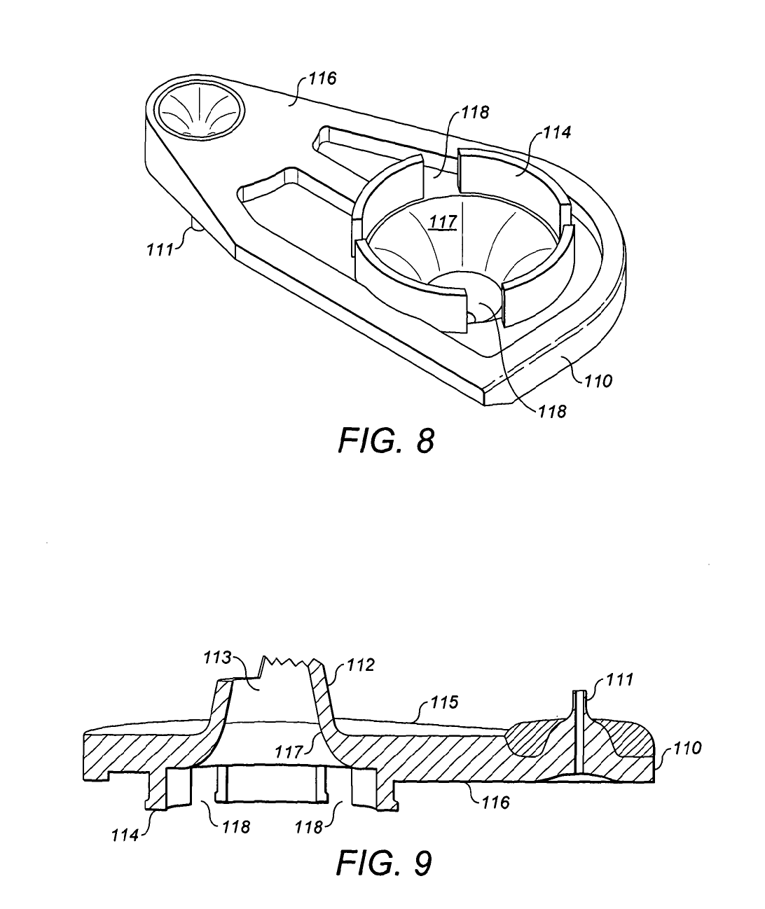

FIG. 8 is a perspective view of a piercer plate according to an embodiment of the present invention shown in an inverted position;

FIG. 9 is a cross-sectional side elevation of the piercer plate of FIG. 8 shown in its correct orientation;

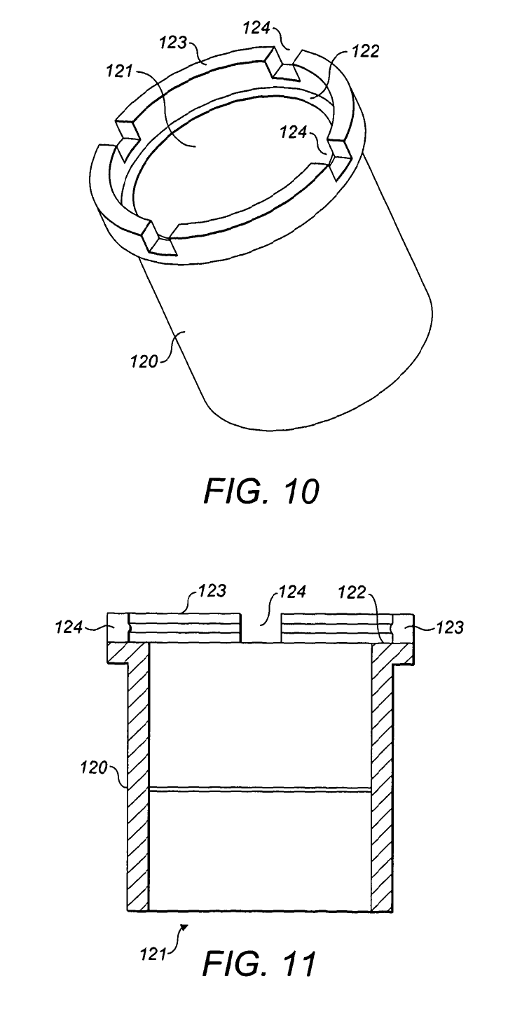

FIG. 10 is a perspective view of a nozzle piece according to an embodiment of the preset invention;

FIG. 11 is a cross-sectional side elevation of the nozzle piece of FIG. 10; and

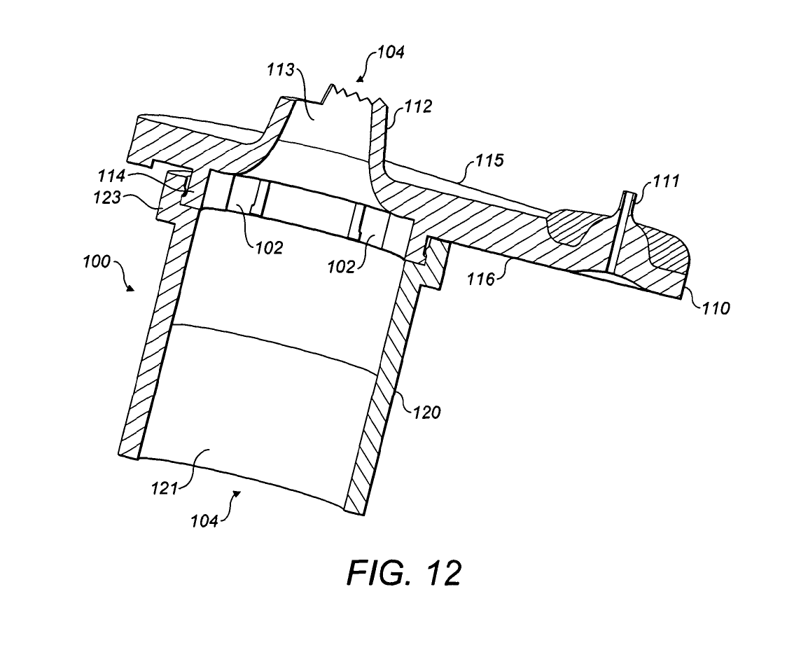

FIG. 12 is a cross-sectional side elevation of the piercer plate of FIG. 8 and the nozzle piece of FIG. 10 when assembled.

In order to cater for the desired wide selection of good-quality beverage types, having different characteristics, the present invention involves one or more significant improvements to known beverage preparation machines. The beverage machine may comprise a soda fountain, beer pump, or the like. The present invention enjoys particular benefit when used with beverage preparation machines for preparing hot beverages like coffee, tea, hot chocolate and hot milk. In particular, the improvements provided by the present invention enable the production of good quality espressos with a high-quality crema, yet provide a design that is easy to keep clean and hygienic, and that is capable of providing other high-quality beverages.

The improvements will be described with reference to a known beverage preparation machine 10 that is illustrated in FIGS. 1 to 7 of the accompanying drawings. It should be noted, however, that the improvements find application in a wide range of beverage preparation machines which may or may not be capable of using a wide range of cartridges which, as noted above, include pods, pads, rigid and semi-rigid cartridges.

The beverage preparation machine 10 of FIGS. 1 to 3 generally comprises a housing 11, a tank 12, a water heater 13, a pump 14, a control processor (not shown), a user interface 16 and a cartridge head 17. The cartridge head 17 in turn generally comprises a cartridge holder 18 for holding, in use, a beverage cartridge 19 and cartridge recognition means 20. The cartridge head 17 further comprises inlet and outlet piercers 21,22 for forming in the beverage cartridge 19, in use, an inlet for liquid to enter the cartridge 19 and an outlet for the prepared beverage to exit the beverage cartridge 19. Beverage leaving the cartridge 19 through the outlet exits the machine 10 from a nozzle piece 70.

Although water is likely to be the most common liquid used in preparing beverages such as coffee, the machine 10 is also capable of handling other liquids, such as milk or milk preparations, for mixing with the beverage ingredients. Any references herein to water should also be taken to include any form of liquid used in preparing beverages.

The housing 11 is preferably made in whole or in part from a suitable plastics material or metal. The housing 11 preferably comprises a clam-shell design having a front half 25 and a rear half 26 which allow access during assembly for fitting of the machine 10 components.

The front half 25 of the housing 11 defines a dispensing station 27 where dispensation of the beverage takes place from the nozzle piece 70. The dispensing station 27 includes a cupstand 23 with a drip tray located beneath. The machine user interface 16 is also located on the front of the housing 11 and comprises a plurality of control switches, for example, a start/stop button 28, and a number of status indicators 29-32. The status indicators 29-32 are preferably light emitting diodes (LED) which, for example, indicate readiness of the machine 10, whether an error has occurred in the machine 10 operation, and the mode of operation of the machine 10. The start/stop button 28 controls commencement of the dispense cycle and is preferably a manually operated push-button, switch or similar.

The tank 12 is located to the rear of the housing 11 and is preferably incorporated in, or connected to, the rear half 26 of the housing 11. The tank 12 has an inlet for filling the tank 12 with water, or other liquid, which is closed off when the tank 12 is in position in the machine 10. An outlet is provided towards a lower end of the tank 12 which communicates with the pump 14. The tank 12 may be made from a transparent or translucent material to allow a consumer to view the quantity of water remaining in the tank 12. Alternatively, the tank 12 may be made from an opaque material but have provided a viewing window therein. In addition, or in place of the above, the tank 12 may be provided with a low level sensor which prevents operation of the pump 14 and optionally triggers a warning indicator, such as an LED, when the liquid level in the tank descends to a preselected level.

The pump 14 is operatively connected between the tank 12 and the water heater 13, and is controlled by the control processor. The flow rate of water through the machine 10 can be controlled by the control processor. A volumetric flow sensor (not shown) is preferably provided in the flow line either upstream or downstream of the pump 14.

The heater 13 is located in the interior of the housing 11. The water for the dispense cycle is delivered to the cartridge head 17 at a predetermined temperature. The heater 13 is able to adjust quickly the delivery temperature to the required temperature, generally between 80° C. and 98° C., and possibly higher from the incoming water temperature. The heater 13 comprises an over-temperature cut-off which shuts off the heater 13 if the temperature exceeds 98° C. Where desired, the machine 10 can incorporate a steam purge. The preferred means of generating the steam purge is to utilise a water heater 13 in the form of a flash heater (also known as an instantaneous or flow heater).

Typically such flash heaters comprise a tube through which the water passes wherein the tube is heated by one or more resistive elements. The flash heater can be used not only for heating water for forming beverages but also, at higher power settings, for generating a steam purge by boiling off water remaining with the flash heater tube after the beverage has been formed. An advantage of flash heaters is that there is no significant delay whilst water in a boiler heats up. Flash heaters heat water on demand and switch off immediately after each brewing cycle and are therefore very energy efficient.

Water output from the heater 13 is fed via a suitable delivery system to the cartridge head 17 and cartridge 19 by means of a valve. If the pressure of the water flow is acceptable, the water is passed to the cartridge 19. If the pressure is below or above predetermined limits then the water is diverted by means of the valve to a waste recovery receptacle.

The delivery system comprises conduits that connect the tank 12, the water pump 14, the water heater 13 and the cartridge head 17 (as shown in FIG. 8) to transport the water from the tank 12 to the cartridge 19.

The cartridge holder 18 is designed to be capable of handling the opening forces generated by the pressure inside the cartridges 19, which is around 250 kg for espresso beverages. During operation of the machine 10 the cartridges 19 attempt to expand, but the integrity of the cartridges 19 must be maintained. In addition the user must not be able to open the holder 18 whilst the system is pressurised and suitable locking mechanisms are provided to achieve this.

One suitable design of cartridge head 17, as described in WO-A-2006/014936, is shown in FIGS. 4 to 7. The cartridge holder 18 of the cartridge head 17 comprises a fixed lower part 43, a rotatable upper part 44 and a pivotable cartridge mount 45 positioned between the fixed lower part 43 and the rotatable upper part 44. The upper part 44, lower part 43 and cartridge mount 45 are rotated about a common hinge axis 46. FIGS. 4 to 7 show the holder 18 with some components of the machine 10 omitted for clarity.

The cartridge mount 45 is provided with a substantially circular recess 55 which receives in use the beverage cartridge 19. The recess 55 includes an irregularity 56 for accommodating a handle portion of the beverage cartridge 19 which also acts to prevent rotation of the beverage cartridge 19 in the holder 18. The cartridge mount 45 is sprung relative to the fixed lower part 43 such that in the open position, as shown in FIG. 7, the cartridge mount 45 is biased out of contact with the fixed lower part 43. The cartridge mount 45 then moves out of contact with the outlet and inlet piercer members 21, 22. The cartridge mount 45 is provided with an aperture 57 for receiving there through the inlet and outlet piercers 21, 22 and a head of the cartridge recognition means 20 when the cartridge mount 45 is moved into the closed position.

The upper part 43 comprises a generally circular body 58 housing a circular viewing window 59 through which a consumer can view the beverage cartridge 19 during a dispense cycle and can also confirm visually whether a cartridge 19 is loaded in the machine 10. The viewing window 59 is cup-shaped having a downwardly directed rim. In addition, the viewing window 59 is provided with a clamping member in the form of an inwardly directed tubular extension 61 as shown in FIG. 7. The extension 61 is directed towards the lower part 44 and lies within the volume of the cartridge head 17 when in the closed position as shown in FIG. 6. When the cartridge holder 18 is in the closed position, a distal end 62 of the tubular extension 61 of viewing window 59 bears against the clamping surface 19a of the beverage cartridge 19 biasing it against the lower part 44 as shown in FIG. 6 (in which the arrangement is illustrated containing a cartridge 19 having a greater depth). The pressure exerted by the tubular extension 61 ensures a fluid tight seal between the cartridge 19 and the holder 18.

The lower part 43 comprises the inlet and outlet piercers 21, 22 and the head of the cartridge recognition means 20. The inlet piercer 21 comprises a hollow needle-like tube having a sharpened end for perforating a laminate of the beverage cartridge 19 in use. The inlet piercer 21 is in fluid communication with a water conduit 65, as shown in FIG. 7, which passes through the lower part 43 and is connected to an outlet conduit 66 of the water heater 13. The outlet piercer 22 is similar in type to the outlet piercer described in the EP-A-0389141 and EP-A-0 334572. An arcuate portion 67 of the upper end of the outlet piercer 22 is serrated to pierce and eventually cut the laminate of the beverage cartridge 19. The remainder of the upper end is cut back longitudinally of the cylinder at least to the base of the teeth of the serrated portion, as shown at 68, to fold or pull the cut laminate away from the outlet aperture before the beverage is dispensed there through.

Advantageously, the outlet piercer 22 is removable from the lower part 43 to enable it to be thoroughly cleaned, for example, in a dishwasher. The removable outlet piercer 22 is received in a recess in the lower part 43 where it is seated. The inlet piercer 21 and/or the outlet piercer 22 may be made of a metal, such as stainless steel, or from a plastics material. Preferably, the inlet piercer 21 and the outlet piercer 22 are formed as a single, integral unit which is removable from the lower part 43.

In use, the upper part 44 of the holder 18 is movable from an open position in which it is orientated vertically or towards the vertical as shown in FIG. 2, to a closed position in which it is orientated substantially horizontally and in interengagement with the fixed lower part 43 and cartridge mount 45. To close the upper part 44, a user takes hold of it and pulls downwards. Consequently, the upper part 44 rotates which first brings the tubular extension 61 of the viewing window 59 into contact with the clamping surface 19a of the beverage cartridge 19. Continued rotation of the upper part 44 rotates the upper part 44 and cartridge mount 45 down into contact with the lower part 43.

With the upper part 44 closed, the piercer 22 has formed the outlet through the laminate provided in the cartridge 19. The outlet piercer 22 has a hollow centre 22a that extends downwardly through the fixed lower part 43 to communicate with the internal bore 71 of the nozzle piece 70. As can be seen best in FIGS. 6 and 7, a conduit extends from the outlet piercer 22 to the base of the nozzle piece 70. The nozzle piece 70 is provided with a central dispensing passage 72 and a peripheral air inlet passage 73. The entrance to the central dispensing passage 72 is positioned directly beneath the centre of the outlet piercer 22 such that beverage flowing from the cartridge 19 falls through the central dispensing passage 72 and out of the nozzle piece 70.

The air inlet passage 73 extends from the base of the nozzle piece 70 to the top of the nozzle piece 70 where it meets the base of the outlet piercer 22. Thus, air may be drawn up and to the cartridge 19. The cartridge 19 may be designed to cause air to become entrained in the flow of beverage as it exits the cartridge 19. For example, the cartridge 19 may include a venturi passage or other feature that causes air to become entrained in the flow of beverage. In this case, the air inlet passage 73 allows the air to be drawn up to the cartridge 19 for entrainment. Where a foam is not desired, the cartridge 19 is designed such that air is not entrained. For example, the cartridge 19 may lack an inlet that is otherwise required to admit an air flow provided by the air inlet passage 73. Further details of such cartridge designs can be found in EP-A-1440903.

While the airflow is important in forming the desired crema in drinks like espresso coffee, and foams in other beverages such as hot chocolate or milk, in practice it has been found that beverage may also flow down the air inlet passage 73 and then from the nozzle piece 70. This flow of beverage has several disadvantages. The flow of beverage impedes the flow of air up the air inlet passage 73 to the detriment of the quality of the crema produced. Also, the flow of beverage down the air inlet passage 73 necessitates that the passage 73 be cleaned regularly, an operation that is hampered by the fact that the air inlet passage 73 is generally much smaller than the central dispensing passage 72.

Control of the brew cycle is effected by the control processor of the beverage preparation machine 10, the central processor comprising a processing module and a memory. The control processor is operatively connected to, and controls operation of, the heater 13, pump 14, user interface 16, and other components described below.

The operational behaviour of the machine 10 is determined by software embedded in the control processor, for example as described in EP-A-1440644. The memory of the control processor includes one or more variables for one or more operational parameters for the beverage preparation machine 10. In the prior art machines these are generally the temperature of the liquid passed through the beverage cartridge 19 during the operating stage, the speed of charging the beverage cartridge 19, the presence or otherwise of a soak step, the total dispensed volume of the beverage, the flow rate of the liquid during the discharge stage, and the period of the purge stage.

One purpose of the cartridge recognition means 20 is, inter alia, to allow the machine 10 to recognise the type of beverage cartridge 19 that has been inserted and to adjust one or more operational parameters accordingly. The variables for the operational parameters are stored in the memory. The cartridge 19 comprises a code provided on or in the cartridge 19 representing the operational parameters required for optimal dispensation of the beverage in that cartridge 19. An example of the code is described in EP-A-1440644.

The control processor memory further stores information on the type of beverage dispensed so that the operating cycle of the machine 10 may be adjusted for the next cartridge 19. This is especially advantageous where two or more beverage cartridges 19 are used sequentially to form a beverage. For example a coffee cartridge may be used followed by a milk cartridge to form a cappuccino beverage. Alternatively a chocolate cartridge could be used followed by a milk cartridge to produce a creamy hot chocolate beverage. By using a memory that stores information on the first beverage dispensed, the manner of dispensing the second cartridge, say a milk cartridge, may be altered to achieve an optimum beverage. In the above example the milk dispensed for hot chocolate may, typically, be diluted less than the milk added to the coffee. In addition, the milk dispensed for chocolate may be dispensed at a slower flow rate to lessen the degree of foaming of the beverage. Many combinations of cartridges are possible and operating parameters as will be obvious to the skilled person. In addition, the memory may be used to allow the machine 10 to ‘predict’ the type of beverage that a user will next want to dispense. For example, if a user predominantly drinks one beverage type then the machine can instruct the water heater to remain at the optimum temperature for that beverage type.

Operation of the known prior art machines 10 comprises insertion of a beverage cartridge 19 into the cartridge head 17, carrying out a dispense cycle in which the beverage is dispensed, and removal of the cartridge 19 from the machine.

To insert the cartridge 19, the cartridge holder 18 is opened as described above to expose the cartridge mount 45. The cartridge 19 is then placed on the cartridge mount 45 received within the recess 46. The cartridge holder 18 is then closed as described above. During closure the inlet and outlet piercers 21,22 pierce the cartridge 19 to form the cartridge inlet and outlet.

To commence the dispense cycle, the user operates the start/stop button 28. The operating cycle comprises the steps of cartridge recognition and the beverage preparation cycle.

Cartridge recognition is performed by the optical cartridge recognition means 20 as described. Once the barcode has been decoded the operational parameters of the machine 10 are adjusted by the control processor. The preparation cycle is then automatically commenced. The preparation cycle has four main stages, although not all of these are used for all beverage types:

1. Pre-wet

2. Pause

3. Brew stage

4. Purge

In the pre-wet stage the cartridge 19 is charged with liquid from the storage tank 12 by means of the pump 14. The charging with water causes the beverage ingredients in the cartridge to be wetted. The charging may take place at a “fast” flow rate of 600 ml/min or a “slow” flow rate of 325 ml/min. The slow charging rate is particularly useful for cartridges 19 containing viscous liquid beverage ingredients where the ingredients require some dilution before they are able to be pumped at a higher volume flow rate. The volume of liquid injected into the cartridge 19 is selected to ensure that liquid or beverage does not drip out of the cartridge outlet during this stage.

The pause stage allows the beverage ingredients to soak in the liquid injected during the pre-wet stage for a predetermined period of time. Both the pre-wetting and soaking stages are known to increase the yield of the extractibles from the beverage ingredients and to improve the end flavour of the beverage. Pre-wetting and soaking are particularly used where the beverage ingredients are roast and ground coffee.

In the dispense stage, liquid is passed through the cartridge 19 in order to produce the beverage from the beverage ingredients. The temperature of the liquid is determined by the control processor which sends instructions to the heater 13 to heat the liquid passing from the tank 12 to the cartridge head 17. Liquid enters the cartridge holder 18 via an inlet valve and the inlet piercer and then passes into the beverage cartridge 19. Brewing and/or mixing of the beverage in the beverage cartridge 19 occurs, as described in EP-A-1440644, before the prepared beverage exits the cartridge outlet, optionally entrains air into the beverage flow from the air flow provided by air inlet passage 73, flows through the central dispensing passage 72 of the nozzle piece 70 and is directed into a suitably placed receptacle in the dispensing station 27.

During the purge cycle the temperature of the water heater 13 is raised sufficiently high to convert the water remaining in the system to steam and the pressurised steam is blown through the beverage preparation machine 10 and the beverage cartridge 19. This ensures that all beverage is dispensed and that the flow path is cleared ready for dispensing another beverage. The purge cycle may not commence immediately on cessation of the brew/mixing stage to allow for the majority of the fluid to clear the flow path.

Once the operating cycle has been completed, the machine automatically stops and the consumer removes the cartridge 19 by opening the cartridge holder 18 and manually removing and disposing of the cartridge 19. Alternatively, the machine 10 may be provided with an automatic ejection mechanism for removing the cartridge automatically on opening the cartridge holder 18.

An embodiment of the present invention is shown in FIGS. 8 to 12. An outlet nozzle assembly 100 is shown that comprises a piercer plate 110 and an nozzle piece 120, broadly corresponding to those shown in FIGS. 5 and 6. However, the outlet nozzle assembly 100 is advantageously modified to provide an improved air inlet.

The piercer plate 110 provides an inlet piercer 111 and an outlet piercer 112 on its topside. The piercers 111,112 are akin to the piercers 21,22 described previously. Thus the outlet piercer 112 may penetrate a laminate provided in a cartridge 19 to form an outlet. The outlet piercer 112 has a hollow centre 113 that extends through the piercer plate 110 from topside 115 to the underside 116. The outlet piercer 112 surrounds the hollow centre 113 on the topside 115, and is surrounded by a skirt 114 on the underside 116. The hole 113 forming the hollow centre increases in size from topside 115 to underside 116 and in fact curves smoothly such that the internal wall 117 of the hole 113 blends smoothly into the underside 116 of the piercer plate 110, save for the skirt 114. The skirt 114 is provided with four interruptions 118, equally spaced around the skirt 114 at ninety degree intervals.

The nozzle piece 120 is generally cylindrical with a hollow centre 121. The top of the nozzle piece 120 is provided with a brim 122 from which a collar 123 extends. The collar 123 is sized to received the skirt 114 of the piercer plate 110. The piercer plate 110 and nozzle piece 120 may be secured to one another in any convenient fashion, e.g. a snap-fit, a bayonet fitting, screw thread, etc. When joined, the hollow centre 113 of the piercer plate 110 and the hollow centre 121 of the nozzle piece 120 form a passage through which the exiting beverage flows. This passage widens, thereby forming a head space around the flow of beverage exiting the beverage machine 10.

The collar 123 of the nozzle piece 120 is provided with four gaps 124 of a corresponding size to the interruptions 118 provided in the skirt 114 of the piercer plate 110. The gaps 124 are also equally spaced around the collar 123 at ninety degree intervals. When assembled, the interruptions 118 in the skirt 114 are aligned with the gaps 124 in the collar 123. The piercer plate 110 and/or the nozzle piece 120 may have indexing means to ensure that the interruptions 118 and gaps 124 align when the outlet nozzle assembly 100 is assembled. When aligned in this way, the interruptions 118 and gaps 124 form air passages 102 between the central bore 104 of the outlet nozzle assembly 100 and atmosphere. The air passages 102 are formed in the widened portion of the passage, thereby admitting air into the head space around the flow of beverage.

The air passages 102 extend from atmosphere just under the fixed lower part 44 of the cartridge head 18, and allow air to be drawn into the nozzle piece 120. Where air is being entrained in the beverage being dispensed, air entering through the air passage 102 may be drawn up into the beverage machine 10 to the cartridge 19 where it is available for entrainment into the beverage being dispensed from the cartridge 19 through the outlet nozzle assembly 100. This airflow may assist in the formation of a crema or other foam, as described above.

In addition to providing an air flow to replace air being entrained in the beverage as it exits the cartridge 19, the air passages 102 allow an airflow into the nozzle piece 120 to replace air drawn down through the nozzle piece 120 by the flow of beverage. This air flow is present even when dispensing beverages such as tea where air entrainment into the beverage is to be avoided. Thus, positioning the air passages 102 in the head space around the beverage flow as it does not lead to entrainment of air into the beverage flow within the nozzle piece 120. Yet, where entrainment is required, an air flow into the beverage machine 10 is provided that may continue to the cartridge 19 where the air is entrained into the beverage flow.

Moreover, the passages 102 formed by the interruptions 118 and gaps 124 are formed at the top of the nozzle piece 120 such that flow of beverage into the air passages 102 is minimised. This is further aided by the widening of the hole 113 through the piercer plate 110 from the outlet piercer 112 to where it meets the nozzle piece 120. As beverage does not flow through the air passages 102, they will stay clean for far longer. In addition, cleaning the air passages 102 is straightforward. The piercer plate 110 need only be removed from the fixed lower part 44 and, optionally, the nozzle piece 120 may be removed from the piercer plate 110, and then the interruptions 118 and the gaps 124 are easily cleaned. This is to be contrasted with the narrow elongate air inlet passage 73 of FIGS. 6 and 7.

Moreover, adopting the arrangement of FIGS. 6 and 7 by removing the air inlet passage 73 from within the nozzle piece 70 enlarges the passage through the nozzle piece 70.

It will be evident to the person skilled in the art that modifications may be made to the embodiment described above without departing from the scope of the invention as defined by the appended claims.

For example, the number of air passages 102 formed through the outlet nozzle assembly 100 may be varied from the four shown in FIGS. 8 to 12. For example more or less may be used. The size and positioning of the air passages 102 may also be varied, and the sizes of the interruptions 118 and gaps 124 need not be the same. Preferably, an even number of air passages 102 are formed as pairs that are aligned across the skirt 114 and collar 123.

The size of the skirt 114 and the collar 123 may also be varied. Moreover, the sizes of the skirt 114 and collar 123 may be varied, or may be reversed such that the collar 13 of the nozzle piece 120 is received within the skirt 114 provided on the underside of the piercer plate 110.

There may not be a requirement for an outlet piercer 112. For example, the present invention may be used with coffee percolators that dispense brewed coffee through a filter funnel into the outlet nozzle assembly 100. Indeed, the present invention may be used with many types of beverage preparation machines, including those that merely hold and dispense a beverage (e.g. soda siphons, beer taps, etc.). Of course, other types of beverage preparation are envisaged, such as brewing coffee and/or tea or heating beverages such as milk.

The outlet nozzle assembly 100 may comprise further parts, e.g. devices for ensuring the quality of a foam produced with the beverage. These devices may be provided in the central bore 104, for example surfaces that provide a flow interruption. Also, the outlet nozzle assembly 100 may comprise a further part that joins downstream of the one or more air passages 102. For example, this part may include a surface for controlling the foam produced. Thus, the air passages 102 may help form a foam, and further devices in the outlet nozzle assembly 100 may help preserve the foam.

1. A beverage preparation machine configured to dispense a beverage through an outlet nozzle, the outlet nozzle comprising one or more sides defining a conduit between an entrance and an exit through which the beverage may pour down and further comprising one or more air passages, each of the one or more air passages extending through the one or more side walls of the nozzle to provide fluid communication between the conduit and atmosphere, wherein the conduit widens downstream of the entrance to form a wider portion and wherein each of the one or more air passages is located in an elevated position in the wider portion above the exit of the outlet nozzle, such that, in use, air is drawn into a head space around the flow of beverage through the conduit and is not entrained into the beverage flow.

2. The beverage preparation machine of claim 1, wherein the conduit comprises a shoulder to define a narrower portion and the wider portion, and wherein each of the one of more air passages is located in the wider portion at the shoulder.

3. The beverage preparation machine of claim 1, wherein the one or more air passages are paired, with each pair of air passages facing each other across the conduit.

4. The beverage preparation machine of claim 3, wherein the one or more air passages are equally spaced around the outlet nozzle.

5. The beverage preparation machine of claim 1, wherein each of the one or more air passages is located adjacent the entrance to the outlet nozzle.

6. The beverage preparation machine of claim 1, wherein the outlet nozzle comprises first and second parts that join together to form the conduit, and wherein the one or more air passages are formed at the joint between the first and second parts.

7. The beverage preparation machine of claim 6, wherein the first part is provided with a downwardly-extending rim and the second part is provided with an upwardly-extending rim, the two rims being sized such that one is received snugly within the other and being provided with interruptions that are aligned to form air passages through the joint.

8. The beverage preparation machine of claim 1, wherein the machine is arranged to prepare beverages from a cartridge containing one or more beverage ingredients.

9. The beverage preparation machine of claim 8, further comprising a cartridge holder arranged to hold the cartridge and provided with a hole through which beverage exiting the cartridge may flow, the cartridge holder being positioned relative to the outlet nozzle such that the beverage flowing through the hole in the cartridge holder pours into the outlet nozzle.

10. The beverage preparation machine of claim 9, further comprising a piercer positioned to pierce the underside of a cartridge when placed in the cartridge holder, the piercer having a hollow centre to form an outlet for beverage to exit the cartridge, and wherein the entrance to the hollow centre of the piercer forms the entrance to the outlet nozzle.

11. The beverage preparation machine of claim 10, wherein the outlet nozzle comprises first and second parts that join together to form the conduit, with first part comprising the piercer on its topside and a downwardly-extending rim on its underside with the hollow centre of the piercer extending from the topside to within the rim, and the second part comprising an upwardly-extending rim, the two rims being sized such that one is received snugly within the other and being provided with interruptions that are aligned to form air passages through the joint.

12. The beverage preparation machine of claim 11, wherein the hollow centre of the piercer extends through the first part with sides that curve outwardly to merge into the underside of the first part.

13. A method of preparing beverages using the beverage preparation machine of claim 1, comprising causing the machine to dispense a beverage through the outlet nozzle such that substantially no beverage flows through the one or more air passages.

14. The method of claim 13, comprising placing a cartridge containing one or more beverage ingredients into a cartridge holder of the beverage preparation machine, causing the machine to prepare a beverage from the cartridge and to dispense the beverage so prepared through the outlet nozzle such that substantially no beverage flows through the one or more air passages.
